(19) United States
(12) Patent Application Publication
(10) Pub. No.: US 2006/0038609 A1
(43) Pub. Date: Feb. 23, 2006

(54) Method and apparatus for fast power-on of the band-gap reference

(76) Inventors: Giorgio Oddone, Genova (IT); Stefano Sivero, Vergiate (IT); Giorgio Bosisio, Robbiate (IT); Andrea Bettini, Cavenagio Brianza (IT)

Correspondence Address: SAWYER LAW GROUP LLP, P O BOX 51418, PALO ALTO, CA, 94303, US

(21) Appl. No.: 11/124,871

(22) Filed: May 9, 2005

(30) Foreign Application Priority Data
Aug. 23, 2004 (IT) MI2004A 001665

(51) Int. Cl. G05F 1/10

(52) U.S. Cl. 327/539

(57) ABSTRACT

A fast power-on band-gap reference circuit includes a band-gap logic and a band-gap dummy logic. During power-on, both the band-gap logic and the band-gap dummy logic are activated and charges the capacitance of a band-gap line. When an output of the band-gap logic reaches a predetermined value, the band-gap dummy logic is deactivated. Thus, the band-gap dummy logic, with a high drive capability, charges the band-gap capacitance at the same time the band-gap logic starts to generate the compensate temperature voltage. In this manner, the band-gap reference circuit reaches its stable, functional state faster than conventional circuits, in the range of a few microseconds.

### CROSS-REFERENCE TO RELATED APPLICATIONS

This application claims benefit under 35 USC 119 of Italian Application no. M12004A 001665, filed on Aug. 23, 2004.

### FIELD OF THE INVENTION

The present invention relates to band-gap reference circuits, and more particularly to the power-on of the band-gap reference circuit.

### BACKGROUND OF THE INVENTION

During power-on of an electronic device, some circuits require a certain amount of time to reach a functional state in a stable manner. One such circuit is the band-gap voltage reference circuit. The band-gap voltage is used in different circuits inside a memory device. Particularly, it is used in the regulators that control the pumps output voltages. The band-gap voltage should be at its proper value in a short time to avoid the pumps reaching a higher-than-desired value. However, many conventional band-gap reference circuits do not have high drive capabilities. Thus, it is very difficult for these circuits to reach the desired stable reference voltage quickly, i.e., in microseconds. Moreover, with the continuing increase in memory size and the use of the band-gap voltage in many other circuits, the capacitance of the band-gap voltage line is increased as well, requiring high drive capability of the band-gap circuitry.

Accordingly, there exists a need for a method and apparatus for fast power-on of a band-gap reference circuit. Upon power-on, this method and apparatus should reach the desired stable reference voltage in microseconds, charging the band-gap voltage high capacitive line. The present invention addresses such a need.

### SUMMARY OF THE INVENTION

A fast power-on band-gap reference circuit includes a band-gap logic and a band-gap dummy logic. During power-on, both the band-gap logic and the band-gap dummy logic are activated and charges a capacitance of a band-gap line. When an output of the band-gap logic reaches a predetermined value, the band-gap dummy logic is deactivated. Thus, the band-gap dummy logic, with a high drive capability, charges the band-gap capacitance at the same time the band-gap logic starts to generate the compensate temperature voltage. In this manner, the band-gap reference circuit reaches its stable, functional state faster than conventional circuits, in the range of a few microseconds.

### BRIEF DESCRIPTION OF THE FIGURES

FIG. 1 illustrates a preferred embodiment of a fast power-on band-gap reference circuit in accordance with the present invention.

FIG. 2 is a flowchart illustrating a preferred embodiment of a method for fast power-on of a band-gap reference circuit in accordance with the present invention.

### DETAILED DESCRIPTION

The present invention provides a method and apparatus for fast power-on of a band-gap reference circuit. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

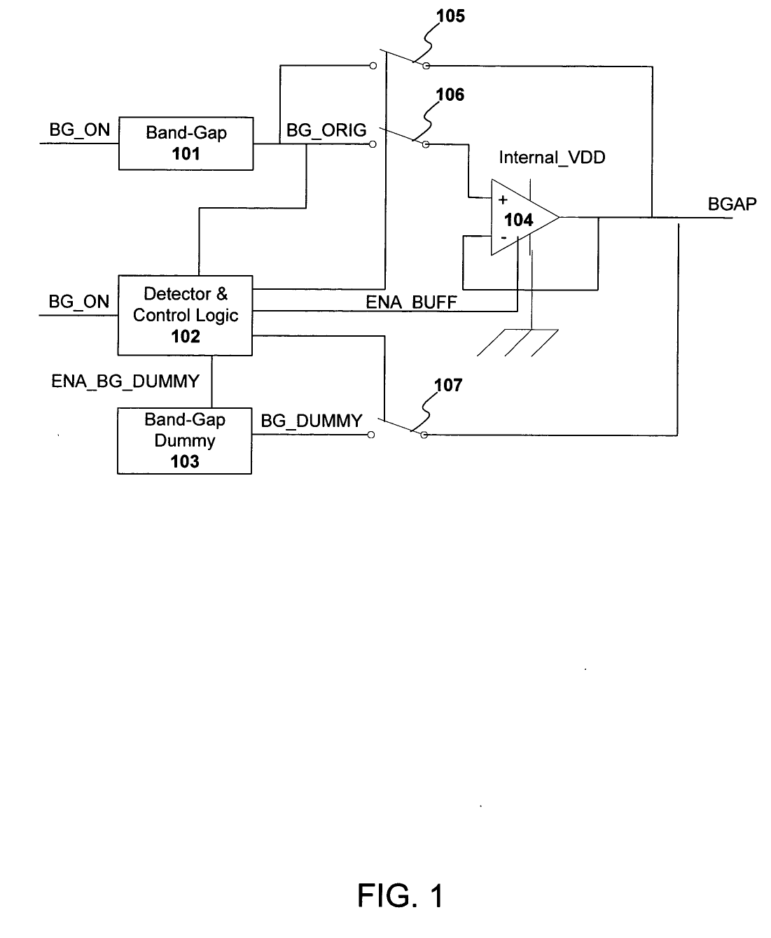

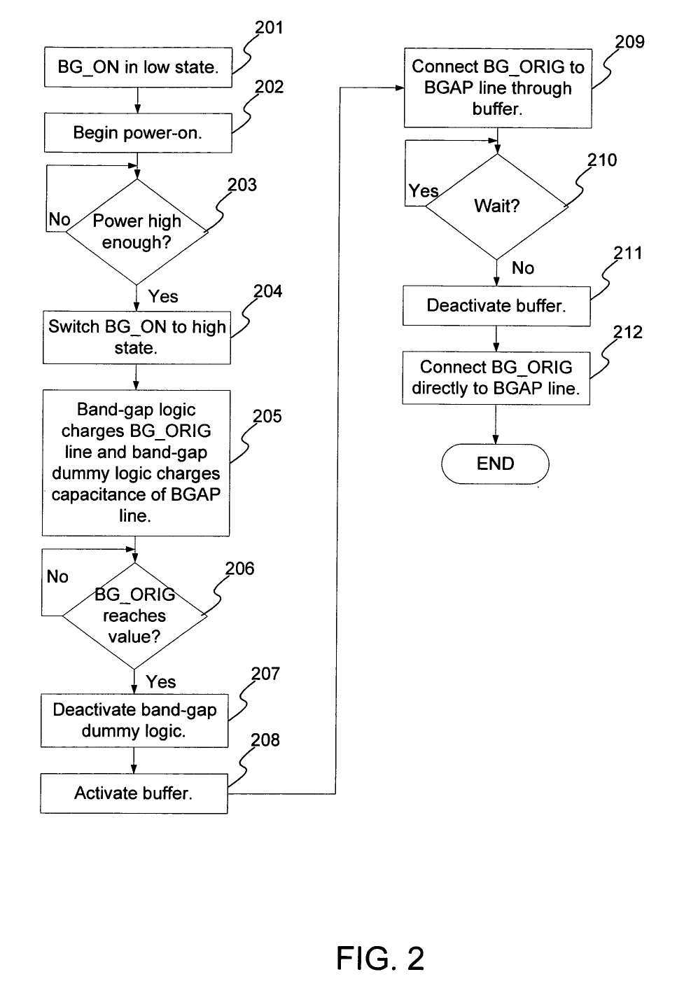

To more particularly describe the features of the present invention, please refer to FIGS. 1 and 2 in conjunction with the discussion below.

The band-gap reference circuit in accordance with the present invention utilizes a band-gap dummy logic with a high drive capability to charge the band-gap capacitance of the line while the true band-gap logic starts to generate the compensated temperature voltage. FIG. 1 illustrates a preferred embodiment of a fast power-on band-gap reference circuit in accordance with the present invention. The band-gap reference circuit includes the band-gap logic 101, a detector and control logic 102, a band-gap dummy logic 103, and a buffer 104, coupled as shown. The band-gap logic 101 receives a BG_ON signal as an input and outputs a BG_ORIG signal. The BG_ORIG signal is capable of being coupled to the buffer 104 or directly to the band-gap output (BGAP). The detector and control logic 102 also receives the BG_ON signal as an input. It outputs signals to control the switches 105-107, a signal (ENA_BUFF) to control the buffer 104, and a signal (ENA_BG_DUMMY) to control the band-gap dummy logic 103. The band-gap dummy logic 103 receives the ENA_BG_DUMMY signal from the detector and control logic 102 as an input and outputs a BG_DUMMY signal. BG_DUMMY signal is capable of being connected directly to the BGAP. The power-on voltage is represented by VDD.

FIG. 2 is a flowchart illustrating a preferred embodiment of a method for fast power-on of a band-gap reference circuit in accordance with the present invention. The BG_ON signal begins in a low state, via step 201. The band-gap reference circuit is then powered-on, via step 202. When the power is high enough to start generating the compensate temperature voltage, via step 203, the BG_ON signal is switched from its low state to a high state, via step 204. At this point, both the band-gap logic 101 and the band-gap dummy logic 103 are activated, via step 205. The band-gap logic 101 generate the BG_ORIG voltage value and charges only a small capacitor placed locally. The band-gap dummy logic 103 charges a high capacitance of the band-gap (BGAP) line. Here, the band-gap dummy logic 103 has a high drive capability to charge the band-gap capacitance at the same time the band-gap logic 101 starts to generate the temperature compensated voltage.

When BG_ORIG reaches the appropriate value, via step 206, the detector and control logic 102 deactivates the band-gap dummy logic 103, via step 207, and activates the buffer 104, via step 208. The detector and control logic 102 connects BG_ORIG to the BGAP line through the buffer 104, via step 209, by having the switch 106 closed and the switch 105 open. After waiting a predetermined amount of time, via step 210, the detector and control logic 102 deactivates the buffer 104, via step 211, and connects BG_ORIG directly to the BGAP line, via step 212, by having the switch 105 closed and the switch 106 open.

Here, the band-gap dummy logic 103 depends upon the temperature and in part on VDD. The buffer 104 is used to provide the current when the voltage value of the band-gap line previously charged by the band-gap dummy logic 103 is lower than BG_ORIG, and to sink the current when it is higher than BG_ORIG. The buffer 104 is also used to externally measure the value of the BGAP line. To avoid problems of clock feedthrough, all the switches 105-107 are compensated with a dummy switch (not shown), and a careful layout of the circuit is adopted to limit the clock feedthrough. To further reduce errors introduced by the buffer 104 during external measurements, and mismatches in all the circuitry, common centroid structure is used for the transistors in the circuit and for the dummy structure.

A fast power-on band-gap reference circuit has been disclosed. This circuit uses a band-gap dummy logic with a high drive capability to charge the band-gap capacitance at the same time the band-gap logic starts to generate the compensate temperature voltage. In this manner, the band-gap reference circuit reaches its stable, functional state faster than conventional circuits, in the range of a few microseconds.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A fast power-on band-gap reference circuit, comprising:
a band-gap logic; and
a band-gap dummy logic,
wherein during power-on, both the band-gap logic and the band-gap dummy logic are activated, are coupled to a band-gap line, and charges a capacitance of the band-gap line,
wherein when an output of the band-gap logic reaches a predetermined value, the band-gap dummy logic is deactivated.

2. The circuit of claim 1, further comprising:
a buffer coupled to the band-gap line, wherein when the output of the band-gap logic reaches the predetermined value, the buffer is activated and the output of the band-gap logic is coupled to the buffer.

3. The circuit of claim 2, wherein after waiting for a predetermined period of time, the buffer is deactivated and the output of the band-gap logic is directly coupled to the band-gap line.

4. The circuit of claim 1, further comprising:
a detector and control logic for activating and deactivating the band-gap logic and the band-gap dummy logic.

5. A fast power-on band-gap reference circuit, comprising:
a band-gap logic;
a band-gap dummy logic, wherein during power-on, both the band-gap logic and the band-gap dummy logic are activated, the band-gap dummy logic is coupled to a band-gap line, and charges a capacitance of the band-gap line, wherein when an output of the band-gap logic reaches a predetermined value, the band-gap dummy logic is deactivated;
a buffer coupled to the band-gap line, wherein when the output of the band-gap logic reaches the predetermined value, the buffer is activated and the output of the band-gap logic is coupled to the buffer, wherein after waiting for a predetermined period of time, the buffer is deactivated and the output of the band-gap logic is directly coupled to the band-gap line; and
a detector and control logic for activating and deactivating the band-gap logic, the band-gap dummy logic, and the buffer.

6. A method for fast power-on of a band-gap reference circuit, comprising:
charging a capacitance of a band-gap line of the circuit by a band-gap logic and a band-gap dummy logic;
determining if an output of the band-gap logic has reached a predetermined value; and
deactivating the band-gap dummy logic, if the output of the band-gap logic has reached the predetermined value.

7. The method of claim 6, further comprising:
activating a buffer, if the output of the band-gap logic has reached the predetermined value;
coupling the output of the band-gap logic to the buffer; and
after a predetermined period of time, deactiving the buffer and coupling the output of the band-gap logic directly to the band-gap line.

8. A method for fast power-on of a band-gap reference circuit, comprising:
charging a capacitance of a band-gap line of the circuit by a band-gap logic and a band-gap dummy logic;
determining if an output of the band-gap logic has reached a predetermined value;
deactivating the band-gap dummy logic and activating a buffer, if the output of the band-gap logic has reached the predetermined value;
coupling the output of the band-gap logic to the buffer; and
after a predetermined period of time, deactiving the buffer and coupling the output of the band-gap logic directly to the band-gap line.
